(19) United States
(12) Patent Application Publication
(10) Pub. No.: US 2018/0180471 A1
(43) Pub. Date: Jun. 28, 2018

(54) Light Receiver Having a Plurality of Avalanche Photodiode Elements in Geiger Mode and Method for Temperature Compensation

(71) Applicant: SICK AG, Waldkirch (DE)

(72) Inventors: Martin MARRA, Waldkirch (DE); Stefan SEITZ, Waldkirch (DE)

(21) Appl. No.: 15/843,492

(22) Filed: Dec. 15, 2017

(30) Foreign Application Priority Data
Dec. 22, 2016 (EP) 16206063.6

(51) Int. Cl. G01J 1/44; G01J 1/42; G01S 7/486; G06K 7/14

(52) U.S. Cl. CPC G01J 1/44; G01J 1/4228; G01J 2001/444; G06K 7/1408; G01J 2001/4466; G01S 7/4865

(57) ABSTRACT

A light receiver (22) comprising

a plurality of avalanche photodiode elements (24),
a first terminal (40) and a second terminal (42) for supplying a bias voltage so that the avalanche photodiode elements (24) are biased with a bias voltage above a breakdown voltage and thus operated in a Geiger mode,
at least one temperature measuring element (44) for measuring an operating temperature of the avalanche photodiode elements (24)
and a voltage compensation unit (46) for adapting the bias voltage to the operating temperature.

The invention relates to a light receiver having a plurality of avalanche photodiode elements in Geiger Mode, and to a method for temperature compensation.

The function of a light receiver is to generate an electrical signal from incident reception light. The detection sensitivity of simple photodiodes is not sufficient in many applications. In an avalanche photodiode (APD), the incident light triggers a controlled avalanche breakdown (avalanche effect). This multiplies the charge carriers generated by incident photons, and a photo current is produced, which is proportional to the light reception level, but significantly larger than in a simple PIN diode. In a so-called Geiger mode, the avalanche photodiode is biased above the breakdown voltage so that even a single charge carrier generated by a single photon can trigger an avalanche, which subsequently recruits all available charge carriers due to the strong field. Hence, the avalanche diode counts individual events like a Geiger counter from which the name is derived. Geiger mode avalanche photodiodes are also called SPAD (Single Photon Avalanche Diode).

The high radiation sensitivity of SPADs is used in a number of applications. These include medical technology like CT, MRI, or blood tests, optical measuring technology like spectroscopy, distance measurement and three-dimensional imaging, radiation detection in nuclear physics, or uses in telescopes for astrophysics.

Geiger APDs or SPADs thus are very fast, highly sensitive photodiodes on a semiconductor basis. One drawback of the high sensitivity is that not only a measurement photon, but also a weak interference event from ambient light, optical cross talk or dark noise may trigger the avalanche breakdown. The interference event contributes to the measurement signal with the same relatively strong signal as the received measurement light and is indistinguishable within the signal. The avalanche diode subsequently is insensitive for a dead time of about 5 to 100 ns and is unavailable for further measurements during that time. It is therefore common to interconnect and statistically evaluate multiple SPADs.

The breakdown voltage is the minimal bias voltage necessary for maintaining the desired Geiger mode for a SPAD. Strictly speaking, however, the detection efficiency and the gain are still zero at this limit. Only when the bias voltage exceeds the breakdown voltage are incident photons converted into corresponding Geiger current pulses. In case of ideal photon detection efficiency (PDE) of 100%, each incident photon would trigger a Geiger current pulse. This is not completely possible in practice. However, the PDE can be influenced by the magnitude of the applied bias voltage.

In order to set the operating point of the SPADs and accordingly their triggering sensitivity via a bias voltage provided externally, the anode-side and cathode-side connections of the individual SPAD cells of the light receiver are directly accessed from the outside. Instead of the bias voltage, sometimes only the overvoltage is considered, i.e. the difference between bias voltage and breakdown voltage. The triggering probability increases with the overvoltage. In practice, there is a reasonable upper limit, because the triggering probability saturates at higher overvoltages, while undesired noise components increase disproportionately.

The magnitude of the breakdown voltage is physically determined by the PN junction of the semiconductor process. Therefore, the breakdown voltage of a SPAD depends correspondingly on the temperature. For example, the breakdown voltage at room temperature is about 28 V, and the associated temperature coefficient is in the order of 20-30 mV/K. A typical value for the overvoltage is 0.5 V to 6 V, depending on the selected operating point or the desired triggering probability, respectively, wherein temperature influences on the overvoltage itself can be regarded as negligible. An industrial sensor can be subject to operating temperature fluctuations of 60-100 K due to self-heating and different ambient temperatures. Consequently, there can be fluctuations in the overvoltage of a few volts which considerably shift the operating point.

Therefore, compensation is necessary in order to maintain a constant sensitivity of the light receiver at a variable operating temperature. Conventionally, a separate external temperature sensor is used, which is arranged at the light receiver with thermal coupling. The temperature information is used to adapt the bias voltage. There are not only disadvantages of increased space requirements and higher production costs by additional components for measuring the temperature, deriving the necessary adaption and changing the bias voltage accordingly. The conventional temperature sensor also does not accurately measure the relevant operating temperature of the SPADs. This is due to the geometric conditions, thermal resistances and coupling paths to the SPADs and neighboring components and, specifically in case of rapidly changing temperatures or thermal oscillations, time delays and inaccuracies caused by different thermal inertia of the components.

WO 2011/117309 A2 proposes to provide, in addition to the anode and cathode for providing the bias voltage, a third electrode on the SPAD detector, the third electrode being used for a capacitively coupled output of the Geiger current. This is to prevent that the readout is delayed by switching elements of the bias voltage. However, the document does not discuss temperature compensation.

It is therefore an object of the invention to provide a more reliable operation of a light receiver having SPADs.

This object is satisfied by a light receiver comprising a plurality of avalanche photodiode elements, a first terminal and a second terminal for supplying a bias voltage so that the avalanche photodiode elements are biased with a bias voltage above a breakdown voltage and thus operated in a Geiger mode, at least one temperature measuring element for measuring an operating temperature of the avalanche photodiode elements and a voltage compensation unit for adapting the bias voltage to the operating temperature.

The object is also satisfied by a method for temperature compensation in a light receiver, the light receiver having a plurality of avalanche photodiode elements, wherein a bias voltage is supplied to the light receiver so that the avalanche photodiode elements are biased with a bias voltage above a breakdown voltage and thus operated in a Geiger mode, wherein an operating temperature of the avalanche photodiode elements is measured and the light receiver adapts the bias voltage to the operating temperature.

The light receiver comprises connections on the anode and the cathode for supplying an external bias voltage which is connected to the avalanche photodiode elements in the light receiver. If the bias voltage is above the breakdown voltage, the avalanche photodiode elements operate in a Geiger mode, wherein the overvoltage, i.e. a portion of the bias voltage exceeding the breakdown voltage, sets the operating point and in particular the triggering probability. The invention starts from the basic idea that the light receiver itself adapts the bias voltage to its operating temperature. To this end, a temperature measuring element is provided which determines the operating temperature, wherein the measurement is not necessarily in a usual unit like ° C. or K, but may for example also be temperature-dependent raw information like a voltage or a current in the temperature measuring element. A voltage compensation unit adapts the bias voltage in accordance with the measurement information of the temperature measuring element.

The invention has the advantage that the light receiver in itself already is temperature compensated. Consequently, there is no need to consider temperature dependence in a device using the light receiver, or in its control or the like. External circuit or control costs are eliminated. The temperature compensation has no relevant space requirements in a device and also within the light receiver. There is a particularly accurate adaption to fluctuations in the operating temperature, with lower susceptibility to interference, protection against destruction and an optimized useful signal.

The voltage compensation unit preferably is configured to adapt a bias voltage supplying the light receiver in dependence on the operating temperature. Thus, a constant bias voltage can be applied from the outside. The voltage compensation unit adjusts this external and typically constant bias voltage by a differential voltage which depends on the measured operating temperature. Throughout this specification, preferably or preferred refers to an advantageous, but completely optional feature.

The voltage compensation unit preferably is configured for voltage subtraction. Preferably, a constant bias voltage is externally applied to the light receiver which is too high, or corresponds to the highest required bias voltage, for example is configured for a highest possible operating temperature. It is particularly easy to provide circuitry for compensating by voltage subtraction. Alternatively, positive compensation would also be possible, provided the higher costs are accepted, which increases an external voltage in dependence on the measured operating temperature, for example by means of a charge pump.

The temperature measuring element preferably is integrated on the light receiver. This facilitates manufacturing of a device using the light receiver because no additional component and no mechanical, thermal and electronic connections are required. In addition, the temperature measured directly on the light receiver is more accurate because the temperature measuring element is in close proximity to the avalanche photodiode elements and is subject to the same thermal influences. The temperature measuring element in particular is generated in the same semiconductor process with the avalanche photodiode elements. Thus manufacturing is further simplified. By integration of the temperature compensation on the light receiver, adjustments can already be done during the semiconductor manufacturing process. The temperature compensation is optimally matched to the variance of the temperature coefficient in the component series. It is also conceivable, as an alternative to a voltage compensation of the light receiver, to merely integrate the temperature measuring element on the light receiver, and to adapt the bias voltage by means of external circuitry.

The temperature measuring element preferably comprises at least one of the avalanche photodiode elements. Then, the same temperature dependence which is to be compensated is also used for the determination of the temperature. An avalanche photodiode element measuring temperature preferably is blind, which at least means that its signal does not contribute to the useful signal of the light receiver and may also mean that such an avalanche photodiode element is optically shielded and possibly also electrically insulated. Otherwise, the avalanche photodiode element's activity could affect the temperature measurement. As an alternative for using an avalanche photodiode element as a temperature measuring element, any other existing or additional PN junction on the light receiver may be used for this purpose.

The voltage compensation unit preferably is configured to adapt the bias voltage in accordance with a voltage change detected by the temperature measuring element. This avoids conversion of the measurement information of the temperature measuring element to a temperature in usual units. In the simplest case, the voltage compensation unit operates like a linear regulator and thus transfers the voltage variations measured at the temperature measuring unit directly to the bias voltage. It is also possible to adapt to any characteristic curve of the temperature measuring element, i.e. to transfer the measured voltage variations to the bias voltage after inversion, attenuation, amplification and/or non-linearly.

The temperature measuring element and the voltage compensation unit preferably are configured as a common circuit component. This results in a particularly simple and clear arrangement. The temperature compensation is combined at one position.

The common circuit component preferably comprises at least one semiconductor series or chain, in particular a diode series or chain. This is a very simple implementation of the idea of having temperature measurement and voltage compensation as a common component. There is a cascade of PN junctions whose temperature effects compensate the operating temperature fluctuations by suitable selection of temperature coefficient and number of the PN junctions.

The temperature measuring unit preferably is configured to measure the operating temperature at a plurality of positions on the light receiver. In particular, a multi-part temperature measuring element is used, for example a plurality of PN junctions or a plurality of avalanche photodiode elements used for temperature measurement. These should have some mutual spacing, or more generally have a suitable geometric distribution for detecting a temperature distribution on the light receiver.

The voltage compensation unit preferably is configured to adapt the bias voltage in accordance with an averaged operating temperature measured at the plurality of positions. The average can also be a weighted average and ensures that the measured operating temperature actually is representative and does not accidentally correspond to a very hot or cool spot. The result is more accurate temperature compensation.

The voltage compensation unit preferably is configured as a multi-channel unit for individually adapting the bias voltage for different groups of avalanche photodiode elements in accordance with different operating temperatures measured at different positions. The term multi-channel also includes a plurality of voltage compensation units. Then, the bias voltage may optimally be adapted even in case of the operating temperature not being the same everywhere on the light receiver. It is conceivable that the temperature is measured at more positions than there are available channels for different bias voltage compensations in that some measurements are combined by averaging.

The light receiver preferably has an active current limiting unit for decreasing the current flowing in the light receiver when a current threshold is exceeded. The current limiting preferably is integrated on the light receiver and protects it from damage. In addition, current limiting may be used as an important parameter for optimizing the signal-to-noise ratio. The main noise source of a light receiver with avalanche photodiode elements in Geiger mode is shot noise, which is composed of dark current noise and noise from interference light. It is advantageous to set a maximum current, since the dark current doubles every 7-10 K and the temperature strongly depends on the intensity of interference light. The specific optimal current limit depends on the respective optical, mechanical and electronic design. When the limit is exceeded, at first the signal-to-noise ratio gets worse, and only at even larger currents there is a risk of damaged components.

The voltage compensation unit is also configured as the current limiting unit. The current flowing in the light receiver depends on the bias voltage. Thus, there are already means for limiting the current in the form of the voltage compensation unit. Due to its dual function, the voltage compensation unit can be used for current limiting at practically no additional costs.

The current limiting unit, or the voltage compensation unit also acting as current limiting unit, preferably is configured to adapt the current threshold to the operating temperature. At lower operating temperatures, larger currents may flow in the light receiver without damage. Since the operating temperature anyway is measured, and thus available to the current limiting unit, the temperature dependence of the maximum current can easily be taken into account and the current threshold from which on the bias voltage needs to be lowered for limiting the current can be adapted to the temperature.

According to another preferred aspect of the invention, there is provided an optoelectronic sensor having at least one light receiver, the light receiver comprising a plurality of avalanche photodiode elements, a first terminal and a second terminal for supplying a bias voltage so that the avalanche photodiode elements are biased with a bias voltage above a breakdown voltage and thus operated in a Geiger mode, at least one temperature measuring element for measuring an operating temperature of the avalanche photodiode elements and a voltage compensation unit for adapting the bias voltage to the operating temperature.

The sensor preferably is configured for measuring distances. The distance can be determined by triangulation, as in a triangulating scanning sensor or a stereo camera. Preferably, the distance is measured with a light time of flight method. In a pulse based method, a light transmitter transmits short light pulses, and the time until reception of a remission or reflection of the light pulse is measured. Alternatively, in a phase method, transmission light is modulated in its amplitude, and a phase shift between transmission light and reception light is measured, wherein the phase shift again is a measure for the light time of flight. The light time of flight method can be used in a one-dimensional ranging sensor, a laser scanner or an image sensor of a 3D camera according to the light time of flight method.

The sensor preferably is configured as a code reader or for data transmission, in particular in a data light barrier capable of transmitting and receiving data via the light path which may additionally be monitored for objects blocking the light path. These are examples of applications. There are other examples, including sensor implementing combinations of the example applications.

The inventive method can be modified in a similar manner and shows similar advantages. Further advantageous features are described in the sub claims following the independent claims in an exemplary, but non-limiting manner.

The invention will be explained in the following also with respect to further advantages and features with reference to exemplary embodiments and the enclosed drawing. The Figures of the drawing show in:

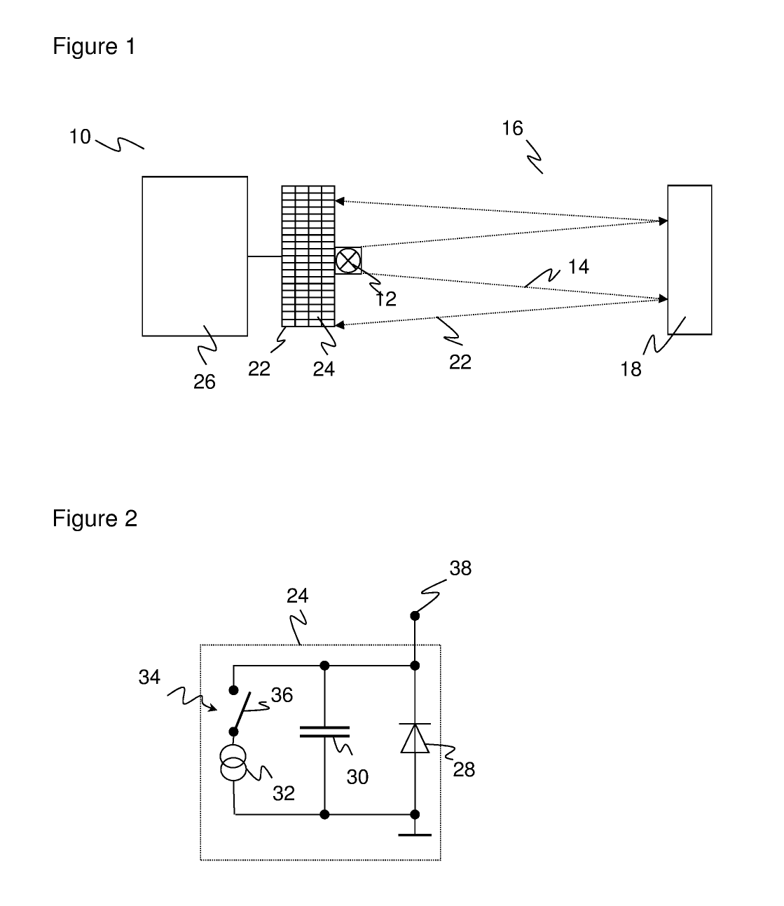

FIG. 1 a schematic representation of an optoelectronic sensor comprising a light receiver having a plurality of avalanche photodiode elements in Geiger mode;

FIG. 2 a simplified block diagram of an avalanche photodiode element in Geiger mode;

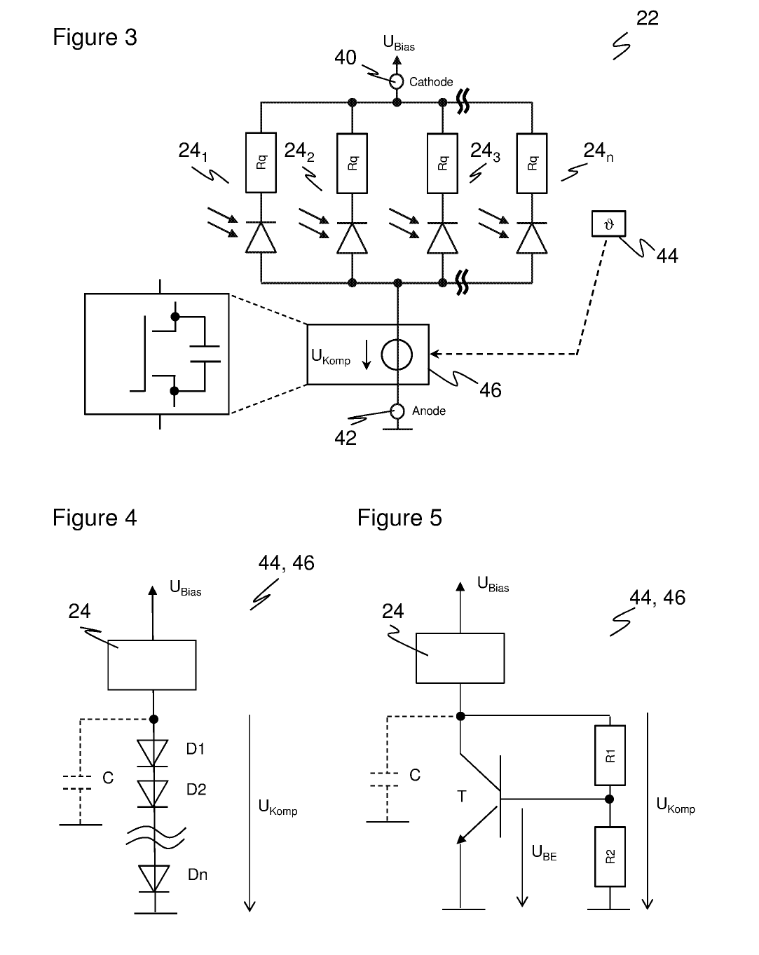

FIG. 3 a schematic circuit diagram of a plurality of avalanche photodiode elements with voltage compensation;

FIG. 4 a circuit diagram of an embodiment of the voltage compensation based on a diode series or diode chain;

FIG. 5 a circuit diagram of an embodiment of the voltage compensation having a transistor and a voltage divider;

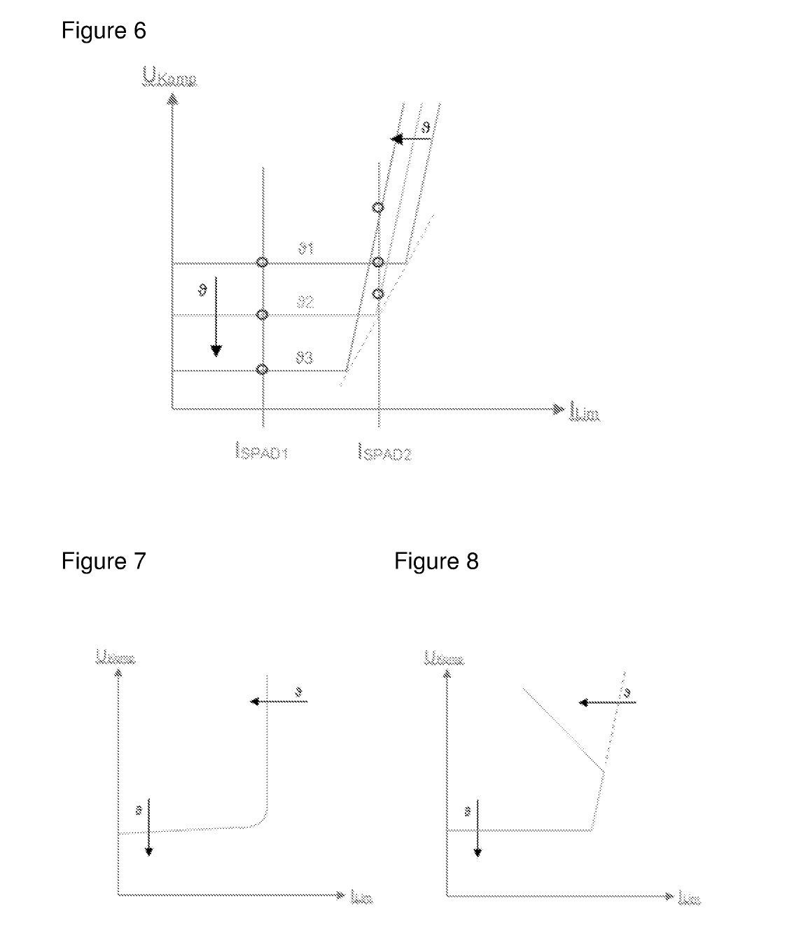

FIG. 6 an exemplary characteristics diagram of the voltage compensation in dependence on current and temperature;

FIG. 7 an alternative characteristic curve with a smooth transition between temperature compensation and current limiting; and

FIG. 8 and alternative characteristic curve where the current limiting is inverted when falling below a voltage threshold.

FIG. 1 shows a schematic representation of an optoelectronic sensor 10 in an embodiment as a single-beam or one-dimensional scanning sensor. A light transmitter 12, for example an LED or a laser light source, transmits a light signal 14 into a monitoring region 16. In case it impinges on an object, part of the light signal is remitted or reflected and returns as remitted light signal 20 to a light receiver 22. The light receiver 22 comprises a plurality of avalanche photodiode elements 24 in Geiger mode or SPADs. The reception signals of the avalanche photodiode elements 24 are read out and evaluated by a control and evaluation unit 26.

In a practical embodiment, the sensor 10 has further elements, in particular transmission and reception optics and connections, which are not further explained for simplification. The separation of light receiver 22 and control and evaluation unit 26 in FIG. 1 is also conceivable in practice, but is mainly done for easier explanation. Preferably, these elements are at least partially integrated on a common chip whose area is shared by light-sensitive regions of the avalanche photodiode elements 24 and circuitry for their control and evaluation associated with individual avalanche photodiode elements 24 or groups of avalanche photodiode elements 24. Moreover, the optical arrangement with a light transmitter 12 covering a small part of the light receiver 22 is merely an example. Alternatively, other known optical solutions can be used, such as autocollimation for example with a beam splitter and common optics, or pupil division where two separate optics are provided and light transmitter and light receiver are arranged side by side.

The sensor 10 preferably is configured to measure distances. One possible embodiment is that the control and evaluation unit 26 determines a light time of flight from transmission of the light signal 14 until reception of the remitted light signal 20, and converts this into a distance via the speed of light.

The illustrated one-dimensional sensor 10 is only an example. An extension of the monitoring region 16 is possible by moving the beam, such as in a laser scanner, be it by a rotating mirror or by a rotating measurement head including light transmitter 12 and/or light receiver 22. In another embodiment, multiple one-dimensional systems are combined to form a light grid having multiple, usually parallel beams. In particular, the light grid is a scanning light grid measuring or monitoring distances with its beams. The avalanche photodiode elements 24 can be used individually or in groups for a spatially resolved measurement, thus forming a 3D camera. Moreover, mobile systems are conceivable where the sensor 10 is movably mounted.

FIG. 2 shows an exemplary simplified circuit diagram of one individual avalanche photodiode element 24 in Geiger mode. In practice, this is a semiconductor component whose actual structure is assumed to be known and is not shown. On the one hand, the avalanche photodiode element 24 shows the behavior of a diode 28. It also has a capacitance, which is represented by capacitor 30 in parallel connection. A possible avalanche breakdown generates charge carriers whose origin is shown as a voltage source 32 in the circuit diagram. The avalanche breakdown is triggered by an incident photon 34, which process acts as a switch 36. Subsequently, there are various ways to evaluate the output signal 38 which will not be discussed in detail.

In a ready state, there is a voltage above the breakdown voltage across the diode 28. In case that an incident photon 34 generates a charge carrier pair, this virtually closes the switch 36 so that the avalanche photodiode element 24 is flooded with charge carriers via the voltage source 32. However, new charge carriers are generated only as long as the electric field remains strong enough. Once the capacitor 30 is discharged by the voltage source 32 to such an extent that the voltage is below the breakdown voltage, the avalanche will automatically run out (“passive quenching”). Thereafter, the capacitor 30 is recharged until the voltage across the diode 28 again exceeds the breakdown voltage. There are alternative configurations in which the avalanche is detected from the outside and then a discharge below the breakdown voltage is triggered (“active quenching”). An avalanche photodiode element 24 thus is capable of detecting even single photons and is therefore suitable for a high sensitivity light receiver 22.

The more the bias voltage exceeds the breakdown voltage, the greater the avalanche, because more charge is available on the capacitor 30 before the voltage drops below the breakdown voltage and the avalanche thus is quenched. The bias voltage thus affects the gain. Variations in the bias voltage also affect the quantum efficiency of the avalanche photodiode element 24 because the size of the drift zone that is formed also depends on the magnitude of the bias voltage. This means that the probability of avalanche triggering by a single photon 34 increases with the bias voltage.

The bias voltage, or an overvoltage exceeding the breakdown voltage, thus sets an operating point of the avalanche photodiode element 24. Therefore, thermal fluctuations of the bias voltage with the operating temperature lead to undesirable variations, and it is advantageous to provide for temperature compensation of the bias voltage.

FIG. 3 shows a schematic circuit diagram of the light receiver having a plurality of avalanche photodiode elements 24₁ . . . 24ₙ, each shown in simplified form as a series connection of a diode and a quench resistor. The bias voltage U_{Bias} is applied at a terminal 40 on the cathode side and a terminal 42 on the anode side of the light receiver 22. Corresponding terminals of the individual avalanche photodiode elements 24₁ . . . 24ₙ are connected to the terminals 40, 42 so that the avalanche photodiode elements 24₁ . . . 24ₙ are biased with U_{Bias}. The specific design of the avalanche photodiode elements 24₁ . . . 24ₙ is purely by way of example, and any known implementation of SPADs also possible, in particular having active quenching or a third terminal with capacitive coupling for reading out the Geiger current in accordance with WO 2011/117309 A2 mentioned in the introduction.

In order to integrate temperature compensation on the light receiver 22, a temperature measuring unit 44 is provided which determines the temperature of the light receiver 22. The temperature information measured by the temperature measuring unit 44 is used in a voltage compensation unit 46 so that the bias voltage applied to the avalanche photodiode elements 24₁ . . . 24ₙ is temperature-independent, i.e. the bias voltage is adapted in dependence on the temperature so that there is a temperature-independent sensitivity.

The temperature measuring unit 44 preferably is integrated in the semiconductor process of the light receiver 22. As the actual temperature sensor, a PN junction on the chip of the light receiver 22 may be used whose temperature coefficient is known, so that voltage changes at the PN junction can be transferred to the avalanche photodiode elements 24₁ . . . 24ₙ based on the temperature coefficient of the avalanche photodiode elements 24₁ . . . 24ₙ. It is particularly advantageous to use one or more of the avalanche photodiode elements 24₁ . . . 24ₙ themselves as the temperature measuring unit 44, since their temperature characteristics are the same as those of the remaining avalanche photodiode elements 24₁ . . . 24ₙ. A temperature-measuring avalanche photodiode element 24₁ . . . 24ₙ preferably is blinded so that the temperature measurement is not affected by its activity when there is incident light.

The voltage compensation unit 46 converts the temperature-dependent voltage information of the temperature measuring unit 44 into an adaptation of the bias voltage. If an avalanche photodiode element 24₁ . . . 24ₙ is used as the temperature measuring unit 44, its voltage value can directly be transferred. Any necessary modification is also possible, such as amplification, inversion, and non-linear adaption. It is also conceivable that the temperature measuring unit 44 does not provide voltage information, but for example a temperature in a conventional unit such as ° C. or K, which can be converted in the voltage compensation unit 46.

Preferably, the externally applied bias voltage U_{Bias} is constant, and the voltage compensation unit 46 generates a temperature-dependent compensation voltage U_{Komp}. In a preferred embodiment, the voltage compensation unit 46 is a voltage subtracting element, for example similar to the operation of a linear regulator. The constant and thus temperature-independent bias voltage U_{Bias} applied externally is high enough in order to provide sufficient reserve for the temperature-dependent voltage subtraction U_{Komp}. In order to limit the resulting losses, the voltage compensation unit 46 preferably generates only small voltage drops and is thus able to operate with low residual voltages (“drop out voltage”). In principle, a voltage increase is also possible as an alternative for a purely voltage subtracting component, for example by means of a charge pump.

Variations of the exemplary circuit as shown are possible. For example, the voltage compensation unit 46 can be arranged in the cathode path instead of in the anode path, the reference potentials can be reversed, i.e. the cathode be connected to ground potential and the anode to a negative bias potential—U_{Bias}, and various semiconductor processes such as bipolar or CMOS are conceivable.

In another embodiment, the temperature measurement unit 44 may include a plurality of sensors distributed on the light receiver 22 to account for local temperature differences. In one variant, the temperatures are averaged, and the voltage is compensated on that basis. Another possibility is to individually compensate different groups of avalanche photodiodes 24₁ . . . 24ₙ in accordance with the local temperature by means of a multi-channel voltage compensation unit 46.

It is conceivable to vary the temperature compensation from external, in particular to switch it on and off. For this purpose, external components such as a resistor or digital means of the light receiver 22 are possible, for example a parameter register. The temperature information could also be provided externally, for example as an analog or digital signal on a PIN connection or via a register access.

FIG. 4 shows a circuit diagram of an embodiment wherein the temperature measuring unit 44 and the voltage compensation unit 46 are combined in a single circuit. In this case, there is provided a semiconductor series or chain, in particular a diode series or chain. It is ensured that the circuit 44, 46 has an appropriate compensation temperature coefficient and thus provides the correct compensation voltage U_{Komp}. A typical value for the temperature coefficient in a Si-based PN junction is −2 mV/K, while in total an order of magnitude of 25 mV/K needs to be compensated for an avalanche photodiode element 24₁ . . . 24ₙ. Therefore, a corresponding number of in this example at least twelve PN junctions is used, wherein due to the series connection the voltage drop and thus the temperature fluctuation adds up to the appropriate compensation voltage U_{Komp}. With a voltage drop of about 0.55 V per PN junction, a total voltage drop of about 6.6 V results, which is significantly higher than for the solution similar to a linear regulator explained with reference to FIG. 3.

FIG. 5 shows another embodiment with a combined temperature measuring unit 44 and voltage compensation unit 46. Instead of a diode series, a transistor and a voltage divider are used, so that the temperature effect of the semiconductor junction is multiplied in accordance with the resistance of the voltage divider, instead of adding up as in FIG. 4.

A combined temperature measurement and voltage compensation unit 44, 46 as in FIGS. 4 and 5 is particularly easy to implement. On the other hand, losses are higher due to the voltage drop of U_{Komp}, and accordingly a higher external bias voltage U_{Bias} has to be provided, and there is an increased self-heating. Additionally, the combination affects the temperature measurement, so that there is a less accurate temperature compensation of the bias voltage of the individual avalanche photodiode elements 24₁ . . . 24ₙ.

FIG. 6 shows a characteristics diagram of the compensation voltage U_{Komp} in dependence on current flow and temperature, in order to further explain possible modes of operation of the voltage compensation unit 46. This in particular relates to an optional additional current limiting mode of the voltage compensation unit 46 which may also be temperature-dependent using the existing temperature measurement unit 44. The current limiting may also be integrated on the light receiver 22 independent of the voltage compensation unit 46 or be implemented externally.

The current limiting is used to protect light receiver 22 against overload. In addition, it ensures that a reasonable operating point still is found in the current limited mode. The activity of the avalanche photodiode elements 24₁ . . . 24ₙ and thus the current flow depends on light incidence and dark noise, the latter increasing with temperature. It is often not possible to limit the maximum ambient light incidence with opto-mechanic means. With too much light or a high operating temperature, respectively, there is a positive feedback because the increasing power dissipation yet again increases the dark noise. Then, there is the danger of destroying the component.

In addition, if there is too much activity especially of ambient light or dark noise events which do not contribute to the intended detection, a large part of the avalanche photodiode elements 24₁ . . . 24ₙ is not available for the actual detection due to dead times. A current limiting by reducing the bias voltage or the overvoltage, respectively, ensures that enough avalanche photodiode elements 24₁ . . . 24ₙ remain available. The current limiting therefore also improves the signal-to-noise ratio. This is also possible with ambient light and a small number of avalanche photodiode elements 24₁ . . . 24ₙ per area, which usually have the better fill factor and thus a higher sensitivity in the limit level range.

In the characteristics diagram of FIG. 6, the left-hand part corresponds to the compensation of the bias voltage which already has been explained with reference to FIGS. 3 to 5, and the right-hand part corresponds to the current limitation or power dissipation limitation. The transition between these modes forms a kink having a temperature-dependent position. The characteristics diagram is just to illustrate the principles of operation and the interaction of temperature compensation and current limitation. The specific slope of the characteristic curves and the position of the temperature-dependent kinks or transitions are only an example. In particular, the desired current limit values may be variable, for example by external components such as a resistor or by digital means such as a parameter register of the light receiver 22.

The left-hand part of the characteristics diagram corresponding to the compensation mode is discussed at a first value I_{SPAD1} of the current. Here, the current remains below the limiting region for all temperatures. For all operating points, the temperature compensation of U_{Bias} is done with a typical temperature coefficient or compensation coefficient of about 20-30 mV/K. In accordance with the horizontal characteristic curve of an ideal voltage source, the voltage drop of U_{Komp} is independent from the current and thus the incident light. This is at least almost possible in practice.

On the other hand, slightly increasing characteristic curves are also conceivable. This means that the triggering probability is slightly decreased for larger currents and thus stronger incident light. When the bias voltage is reduced in accordance with the increasing characteristic curve, the triggering probability is reduced. This effect can for example be used to increase the dynamic range. Technically, the slope can be achieved by adding a simple series resistance in the line for the bias voltage U_{Bias} outside the voltage compensation unit 46. The magnitude of the slope is directly dependent on the resistance value which can be selected between two extremes: no series resistance for a horizontal characteristic curve corresponding to an ideal voltage source, and a near-infinite series resistance for a nearly vertical characteristic curve corresponding to an ideal current source. However, a large slope is not really useful, so that actually a low resistance is preferred. In any case, the characteristic curves should be mutually parallel for optimal temperature compensation, so that they everywhere correspond to the temperature gradient of the avalanche photodiode elements 24₁ . . . 24ₙ.

The right-hand part of the characteristics diagram corresponding to the current limiting mode starts at different currents at respective kinks of the characteristic curves depending on the temperature. At a second value I_{SPAD2} of the current, the operating point is in the regular compensation mode only for the lowest temperature υ1. For the higher temperatures υ2 and υ3, the operating points have already been shifted into the current limiting mode.

Within the current limiting mode, the characteristic curves show a steep drop. Staying in the example of I_{SPAD2} and the higher temperatures υ2 and υ3, the bias voltage is significantly reduced. This reduces the triggering sensitivity of the avalanche photodiode elements 24₁ . . . 24ₙ and thus the current, assuming otherwise equal conditions and in particular the same light incidence. This effect of the bias voltage on the current applies as long as there is a positive overvoltage. Upon reaching the breakdown voltage, or falling below, there is virtually no current flow any more.

Technically, at least nearly vertical characteristic curves corresponding to an ideal current source would be possible. However, some slope, which can vary in dependence on the design of the light receiver 22, would even be advantageous because an operating point can be found. Otherwise, even the slightest current variation, be it due to light incidence or noise, would lead to enormous variations in the bias voltage. A stable operating point in the limiting region would hardly be possible.

The current limiting as explained is active. This makes it possible to apply an optimal, temperature compensated bias voltage in the compensation mode. Upon exceeding the limit current, which is set in dependence on the temperature, or in other words upon transition into the current limiting mode, the voltage is reduced as a protection against excessive power dissipation, and a dynamic equilibrium is found. In contrast, a passive current limiting for example via a resistance would already cause voltage variations at the avalanche photodiode elements 24₁ . . . 24ₙ in the normal operating mode with well-tolerated currents. This does no longer optimally achieve the desired stability of the temperature compensation. In addition to the effects on triggering probability and gain, for avalanche photodiode elements 24₁ . . . 24ₙ having an explicit drift zone for red-sensitivity also a change in spectral sensitivity is possible.

FIGS. 7 and 8 show two further variations of the characteristic curves of FIG. 6 in order to emphasize their exemplary nature. For the sake of clarity, only one characteristic curve for one temperature is shown. The temperature-dependent shift of characteristic curves would be analogous.

The characteristic curve of FIG. 7 shows in the left-hand part a slightly increasing slope. As already explained, this means that the sensitivity slightly decreases with increasing activity of the light receiver 22. In the right-hand part, the characteristic curve is vertical, thus limiting the current abruptly. For compensation, the transition region is not a sharp kink, but a smoothened curve. Here, effects of temperature compensation and current limiting are intermixed.

The characteristic curve of FIG. 8 largely corresponds to FIG. 6, with the difference that in the right part of the current limiting there is a further kink followed by a backwards characteristic curve. The backwards characteristic curve is for limiting the power dissipation across the voltage compensation unit 46 in the event of faults, for example a short-circuit or an avalanche photodiode element 24₁ . . . 24ₙ becoming low-resistive. Otherwise, there could be so much power dissipation that the light receiver 22 is greatly overheated. If, however, it is possible to reduce the current approximately to the same extent as the voltage increases, the power loss is not critical even in the event of a fault. The kink where the backwards characteristic curve follows is preferably below the breakdown voltage in order not to interfere with normal operation. The position of the kink can be set to a fixed value, or again be varied in dependence on the temperature. A backwards characteristic curve as in FIG. 8 is only one conceivable countermeasure for faults. For example, the current could also be reduced to a very small value above a critical limit temperature.

In both cases, a significantly steeper course is obtained in the current limiting mode compared to the compensation mode, which manifests itself in a kink or a smoothened transition region. This is a consequence of the fact that in the compensation mode aiming at temperature compensation there is no or at most little dependence on the current, whereas in the current limiting mode a strong dependency with a relative sharp limit is desired.

In the previous embodiments, all of the avalanche photodiode elements 24₁ . . . 24ₙ are connected to the same voltage source and therefore have the same bias voltage. However, it may be advantageous to connect the avalanche photodiode elements 24₁ . . . 24ₙ to a plurality of groups and bias the groups differently. This creates areas of different sensitivity, because the triggering probability and the gain vary with the bias voltage. However, the specific technical implementation and detailed applications will not be discussed in any detail.

In any case, common temperature compensation is possible even with such a heterogeneous bias voltage. For this purpose, for example, the voltage compensation unit 46 is arranged at a common path, e.g. at the anode-side terminal 42, while the supply of the individual groups of avalanche photodiode elements 24₁ . . . 24ₙ with the respective bias voltage is at the cathode side, or vice versa. In this case, correct temperature compensation is still ensured, because all groups are on the same chip as the voltage compensation unit 46 and the actual temperature-dependent component is the breakdown voltage, which in turn is internally temperature compensated. Furthermore, the bias voltage is the sum of breakdown voltage and overvoltage, and the proportion of the bias voltage that determines the operating point of the groups of avalanche photodiode elements 24₁ . . . 24ₙ is therefore only defined by the overvoltage.

1. A light receiver (22) comprising
a plurality of avalanche photodiode elements (24),
a first terminal (40) and a second terminal (42) for supplying a bias voltage so that the avalanche photodiode elements (24) are biased with a bias voltage above a breakdown voltage and thus operated in a Geiger mode,
at least one temperature measuring element (44) for measuring an operating temperature of the avalanche photodiode elements (24)
and a voltage compensation unit (46) for adapting the bias voltage to the operating temperature.

2. The light receiver (22) according to claim 1,
wherein the voltage compensation unit (46) is configured to adapt a bias voltage supplying the light receiver (22) in dependence on the operating temperature.

3. The light receiver (22) according to claim 1,
wherein the voltage compensation unit (46) is configured for voltage subtraction.

4. The light receiver (22) according to claim 1,
wherein the temperature measuring element (44) is integrated on the light receiver (22).

5. The light receiver (22) according to claim 1,
wherein the temperature measuring element (44) comprises at least one of the avalanche photodiode elements (24).

6. The light receiver (22) according to claim 1,
wherein the voltage compensation unit (46) is configured to adapt the bias voltage in accordance with a voltage change detected by the temperature measuring element (44).

7. The light receiver (22) according to claim 1,
wherein the temperature measuring element (44) and the voltage compensation (46) are configured as a common circuit component (44, 46).

8. The light receiver (22) according to claim 7,
wherein the common circuit component (44, 46) comprises at least one semiconductor series.

9. The light receiver (22) according to claim 1,
wherein the temperature measuring unit (44) is configured to measure the operating temperature at a plurality of positions on the light receiver (22).

10. The light receiver (22) according to claim 9,
wherein the voltage compensation unit (46) is configured to adapt the bias voltage in accordance with an averaged operating temperature measured at the plurality of positions.

11. The light receiver (22) according to claim 9,
wherein the voltage compensation unit (46) is configured as a multi-channel unit for individually adapting the bias voltage for different groups of avalanche photodiode elements (24) in accordance with different operating temperatures measured at different positions.

12. The light receiver (22) according to claim 1,
having an active current limiting unit (46) for decreasing the current flowing in the light receiver (22) when a current threshold is exceeded.

13. The light receiver (22) according to claim 12,
wherein the voltage compensation unit (46) is also configured as the current limiting unit.

14. The light receiver (22) according to claim 12,
wherein the current limiting unit is configured to adapt the current threshold to the operating temperature.

15. An optoelectronic sensor (10) having at least one light receiver (22), the light receiver (22) comprising
a plurality of avalanche photodiode elements (24),
a first terminal (40) and a second terminal (42) for supplying a bias voltage so that the avalanche photodiode elements (24) are biased with a bias voltage above a breakdown voltage and thus operated in a Geiger mode,
at least one temperature measuring element (44) for measuring an operating temperature of the avalanche photodiode elements (24)
and a voltage compensation unit (46) for adapting the bias voltage to the operating temperature.

16. The optoelectronic sensor (10) according to claim 15,
the sensor (10) being configured as a sensor (10) for measuring distances according to a time of flight method.

17. The optoelectronic sensor (10) according to claim 15,
the sensor (10) being configured as a code reader.

18. The optoelectronic sensor (10) according to claim 15,
the sensor (10) being configured for data transmission.

19. A method for temperature compensation in a light receiver (22), the light receiver having a plurality of avalanche photodiode elements (24),
wherein a bias voltage is supplied to the light receiver (22) so that the avalanche photodiode elements (24) are biased with a bias voltage above a breakdown voltage and thus operated in a Geiger mode,
wherein an operating temperature of the avalanche photodiode elements (24) is measured and the light receiver (22) adapts the bias voltage to the operating temperature.
